(19) United States
(12) Patent Application Publication
(10) Pub. No.: US 2024/0378838 A1
(43) Pub. Date: Nov. 14, 2024

(54) VEHICULAR CAMERA WITH POLARIZATION FILTER

(71) Applicant: Magna Electronics Inc., Auburn Hills, MI (US)

(72) Inventor: Xiyuan Liu, Moembris (DE)

(21) Appl. No.: 18/315,601

(22) Filed: May 11, 2023

Related U.S. Application Data
(60) Provisional application No. 63/364,681, filed on May 13, 2022.

(51) Int. Cl. G06V 10/147; B60R 1/12; G06V 20/52; G06V 20/59; G06V 40/10; H04N 23/56; H04N 25/76

(52) U.S. Cl. CPC G06V 10/147; B60R 1/1207; G06V 20/52; G06V 20/59; G06V 40/10; H04N 23/56; H04N 25/76; B60R 2001/1253; G02B 5/30

(57) ABSTRACT

A vehicular occupant monitoring system includes a camera disposed at an interior rearview mirror of a vehicle. A polarization filter is disposed between an imaging array sensor of the camera and occupants of the vehicle such that light reflected off of the occupants of the vehicle passes through the polarization filter prior to reaching the imaging array sensor. The vehicular occupant monitoring system, responsive to processing by the image processor of image data captured by the camera, determines presence of an occupant of the vehicle.

### CROSS REFERENCE TO RELATED APPLICATION

The present application claims the filing benefits of U.S. provisional application Ser. No. 63/364,681, filed May 13, 2022, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular occupant monitoring system includes a camera disposed at an interior rearview mirror assembly of a vehicle equipped with the vehicular occupant monitoring system that views the interior of the equipped vehicle and captures image data. The system includes an electronic control unit (ECU) with electronic circuitry and associated software. The electronic circuitry of the ECU includes an image processor for processing image data captured by the camera. The camera includes a CMOS imaging array sensor and a lens, and the CMOS imaging array includes at least one million photosensors arranged in rows and columns. The system includes a light polarization filter disposed between the CMOS imaging array sensor and the interior of the equipped vehicle such that light reflected off an occupant within the interior of the equipped vehicle passes through the light polarization filter and is polarized by the light polarization filter prior to reaching the CMOS imaging array sensor. The vehicular occupant monitoring system, via processing by the image processor of image data captured by the camera, determines presence of the occupant within the interior of the equipped vehicle

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of an interior rearview mirror;

FIG. 3 is a schematic view of an exemplary field of view of the camera of FIG. 2;

FIG. 4 is an image of reflections captured by a camera of an interior rearview mirror; and

FIG. 5 is an image illustrating the use of a polarization filter.

### DESCRIPTION OF THE PREFERRED EMBODIMENTS

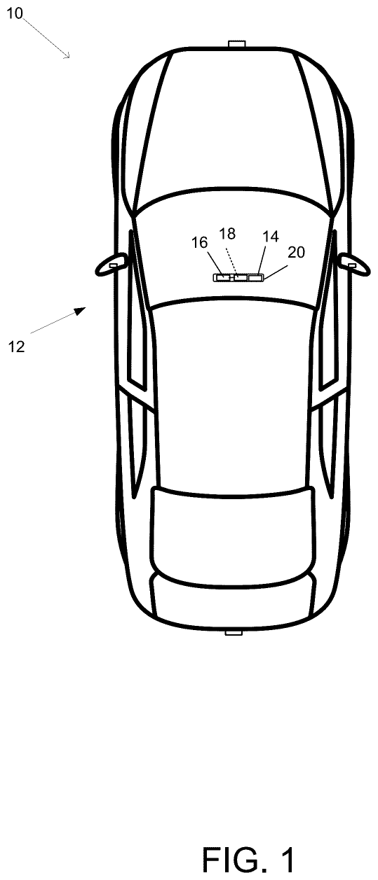

Referring now to the drawings and the illustrative embodiments depicted therein, a vehicle 10 includes an imaging system or vision system 12 that includes at least one interior or driver monitoring camera 14 (FIG. 1). The vision system 12 includes a control (that comprises a processor) or electronic control unit (ECU) 18 that includes electronic circuitry and associated software, with the electronic circuitry comprising a processor that is operable to process image data captured by the camera to monitor the interior of the vehicle (e.g., the driver and/or passengers of the vehicle). The system may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

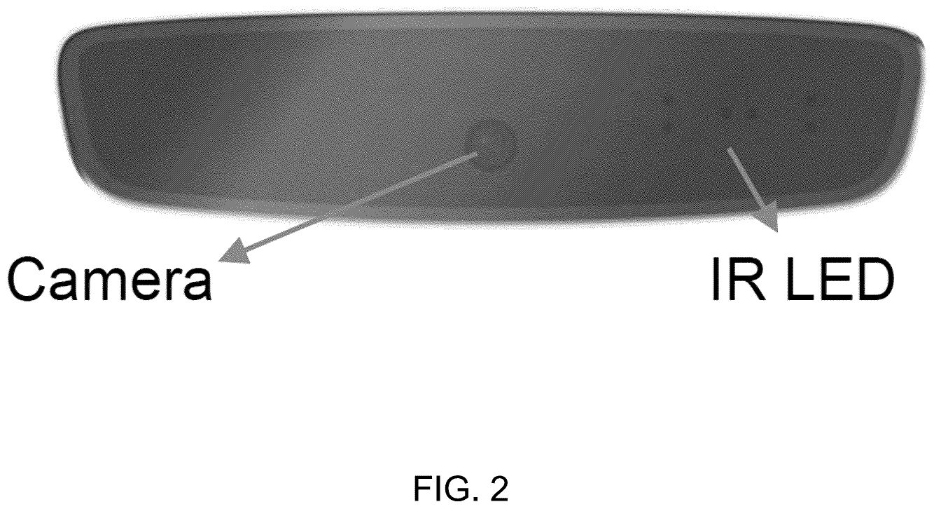

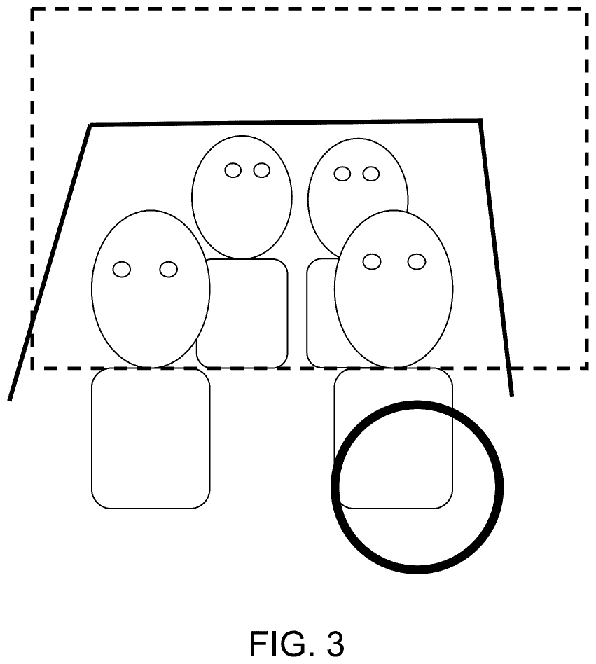

For some driver monitoring systems (DMS) and/or occupant monitoring systems (OMS), an interior camera is integrated into the interior rearview mirror assembly 20. For example, as illustrated in FIG. 2, the rearview mirror includes a camera integrated behind the reflective surface of the mirror reflective element of the rearview mirror assembly. The mirror assembly may also include one or more illumination sources, such as one or more near infrared (near IR) LEDs or visible light LEDs to illuminate the scene for the camera to capture. As shown in FIG. 3, the camera position provides a field of view that includes some or all of the driver and/or passengers of the vehicle for assisting DMS and/or OMS (e.g., for tracking eyes, hands, distraction levels, number of passengers, comfort, health, etc.).

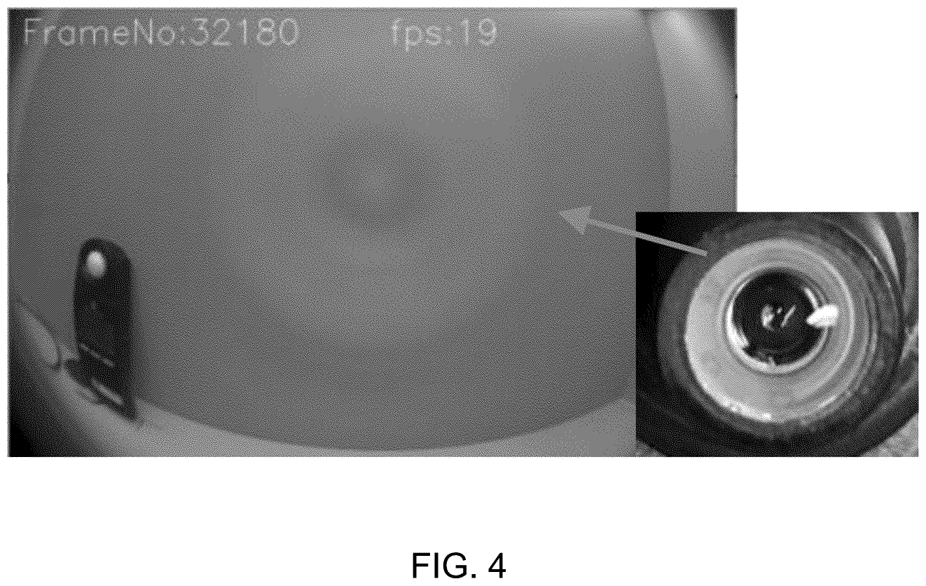

Referring now to FIG. 4, in some scenarios, an unintentional reflection or glare is present in image data captured by the camera. For example, the camera may capture reflections of visible light or IR from the mirror of the rearview mirror assembly, from items within the cabin of the vehicle (e.g., glasses or sunglasses worn by an occupant, windows, etc.). The glare caused by these reflections can impede DMS and OMS functionality.

Implementations herein include a polarization filter in front of the camera. For example, a polarization filter is included at or within the lens of the camera or is placed in front of the lens. For example, the surface of the mirror reflective element of the interior rearview mirror assembly may include a polarization filter that polarizes light that passes through the surface of the mirror reflective element to the camera. The polarization filter may be a coating directly on the lens of the camera or, alternatively, a separate element disposed in front of the lens of the camera. The polarization filter may include a linear polarizer, a circular polarizer, an elliptical light polarizer, or any combination thereof. Optionally, the camera may automatically rotate the polarization filter to minimize reflections/glare. For example, an actuator or the like may rotate the filter (e.g., may rotate a linear polarizer filter to adjust the orientation of the filter) using a rotatable collar, such as to reduce glare of light coming from a particular direction. The system may rotate the filter and capture images at various points during the rotation. Then, the system may compare the images to determine which rotation point resulted in the best image quality (e.g., reduced glare the most). The system may rotate the filter periodically and/or in response to detecting a threshold amount of glare.

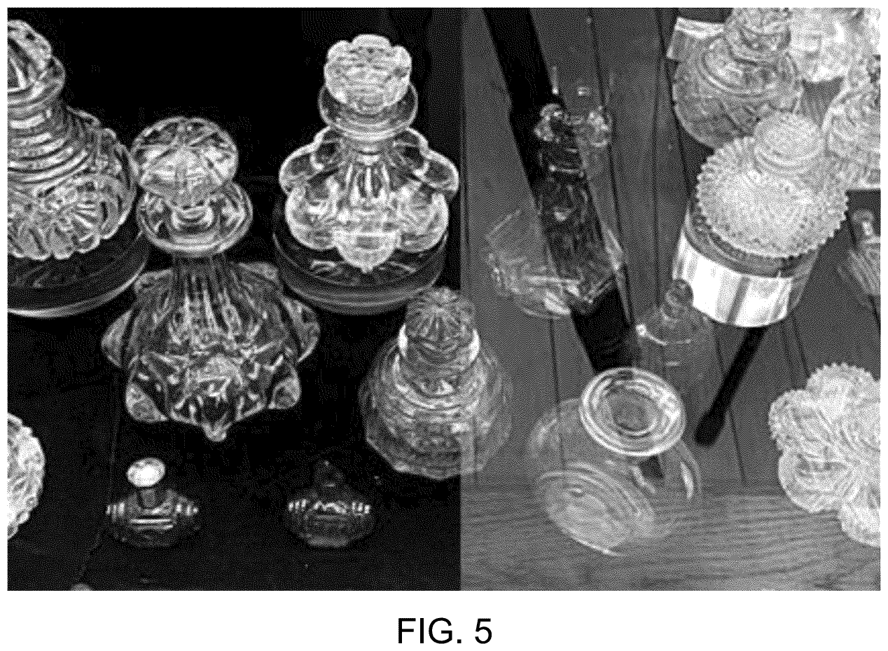

As shown in FIG. 5, a polarization filter greatly reduces glare and reflections (the left side of the image) compared to non-polarized image data (the right side of the image). The polarization filter reduces ghost imaging that results from unintentional reflections between the mirror/lens and other reflective surfaces. By reducing these reflections, OMS and DMS monitoring may be increased and improved. For example, the eyes of an occupant may be tracked more accurately through personal glasses worn by the occupant. The polarization filter may improve the styling of the mirror in a way that the camera behind the mirror is not visible, while the transmittance in the visible light domain is reduced by the polarization filter (i.e., by reducing the amount of light reaching the camera, the camera will become less visible behind the mirror).

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,518,401; 10,958,830; 10,065,574; 10,017,114; 9,405,120 and/or 7,914,187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2022/241423; WO 2022/187805 and/or WO 2023/034956, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular occupant monitoring system, the vehicular occupant monitoring system comprising:
a camera disposed at an interior rearview mirror assembly of a vehicle equipped with the vehicular occupant monitoring system and viewing interior of the equipped vehicle, the camera capturing image data;
an electronic control unit (ECU) comprising electronic circuitry and associated software;
wherein the electronic circuitry of the ECU comprises an image processor for processing image data captured by the camera;
wherein the camera comprises a CMOS imaging array sensor and a lens, and wherein the CMOS imaging array comprises at least one million photosensors arranged in rows and columns;
a light polarization filter disposed between the CMOS imaging array sensor and the interior of the equipped vehicle such that light reflected off an occupant within the interior of the equipped vehicle passes through the light polarization filter and is polarized by the light polarization filter prior to reaching the CMOS imaging array sensor; and
wherein the vehicular occupant monitoring system, via processing by the image processor of image data captured by the camera, determines presence of the occupant within the interior of the equipped vehicle.

2. The vehicular occupant monitoring system of claim 1, wherein the light polarization filter is disposed at the lens of the camera.

3. The vehicular occupant monitoring system of claim 2, wherein the light polarization filter comprises a coating on the lens of the camera.

4. The vehicular occupant monitoring system of claim 1, wherein the light polarization filter is disposed at a mirror reflective element of the interior rearview mirror assembly.

5. The vehicular occupant monitoring system of claim 4, wherein the camera is disposed behind and views through the mirror reflective element of the interior rearview mirror assembly.

6. The vehicular occupant monitoring system of claim 1, wherein the camera is disposed behind and views through a mirror reflective element of the interior rearview mirror assembly.

7. The vehicular occupant monitoring system of claim 1, further comprising a near infrared light emitting diode (LED) disposed at the interior rearview mirror assembly and operable to emit near infrared light to illuminate the interior of the equipped vehicle.

8. The vehicular occupant monitoring system of claim 1, further comprising a light emitting diode (LED) that emits visible light to illuminate the interior of the equipped vehicle.

9. The vehicular occupant monitoring system of claim 1, wherein the camera views at least a portion of the driver of the equipped vehicle.

10. The vehicular occupant monitoring system of claim 9, wherein the vehicular occupant monitoring system determines presence of the driver of the equipped vehicle, and wherein the vehicular occupant monitoring system, responsive to determining presence of the driver of the equipped vehicle, monitors at least one selected from the group consisting of (i) the hands of the driver and (ii) the eyes of the driver.

11. The vehicular occupant monitoring system of claim 1, wherein the camera views at least one passenger present in the interior of the equipped vehicle.

12. The vehicular occupant monitoring system of claim 1, wherein the light polarization filter comprises a linear light polarization filter.

13. The vehicular occupant monitoring system of claim 1, wherein the light polarization filter comprises a circular light polarization filter.

14. The vehicular occupant monitoring system of claim 1, wherein the light polarization filter comprises an elliptical light polarization filter.

15. The vehicular occupant monitoring system of claim 1, wherein the vehicular occupant monitoring system, responsive to detecting glare at the camera, adjusts the light polarization filter to reduce the glare.

16. The vehicular occupant monitoring system of claim 15, wherein adjusting the light polarization filter comprises rotating the light polarization filter.

17. The vehicular occupant monitoring system of claim 15, wherein the light polarization filter comprises a linear light polarization filter.

18. A vehicular occupant monitoring system, the vehicular occupant monitoring system comprising:
a camera disposed at an interior rearview mirror assembly of a vehicle equipped with the vehicular occupant monitoring system and viewing interior of the equipped vehicle, the camera capturing image data, and wherein the camera views at least a portion of the driver of the equipped vehicle;
an electronic control unit (ECU) comprising electronic circuitry and associated software;
wherein the electronic circuitry of the ECU comprises an image processor for processing image data captured by the camera;
wherein the camera comprises a CMOS imaging array sensor and a lens, and wherein the CMOS imaging array comprises at least one million photosensors arranged in rows and columns;
a light polarization filter disposed at the lens of the camera such that light reflected off an occupant within the interior of the equipped vehicle passes through the light polarization filter and is polarized by the light polarization filter prior to reaching the CMOS imaging array sensor; and
wherein the vehicular occupant monitoring system, via processing by the image processor of image data captured by the camera, determines presence of the occupant within the interior of the equipped vehicle.

19. The vehicular occupant monitoring system of claim 18, wherein the light polarization filter comprises a coating on the lens of the camera.

20. The vehicular occupant monitoring system of claim 18, further comprising a near infrared light emitting diode (LED) disposed at the interior rearview mirror assembly and operable to emit near infrared light to illuminate the interior of the equipped vehicle.

21. The vehicular occupant monitoring system of claim 18, further comprising a light emitting diode (LED) that emits visible light to illuminate the interior of the equipped vehicle.

22. A vehicular occupant monitoring system, the vehicular occupant monitoring system comprising:
a camera disposed at an interior rearview mirror assembly of a vehicle equipped with the vehicular occupant monitoring system and viewing interior of the equipped vehicle, the camera capturing image data, and wherein the camera views at least one passenger present in the interior of the equipped vehicle;
an electronic control unit (ECU) comprising electronic circuitry and associated software;
wherein the electronic circuitry of the ECU comprises an image processor for processing image data captured by the camera;
wherein the camera comprises a CMOS imaging array sensor and a lens, and wherein the CMOS imaging array comprises at least one million photosensors arranged in rows and columns;
a light polarization filter disposed at a mirror reflective element of the interior rearview mirror assembly such that light reflected off an occupant within the interior of the equipped vehicle passes through the light polarization filter and is polarized by the light polarization filter prior to reaching the CMOS imaging array sensor; and
wherein the vehicular occupant monitoring system, via processing by the image processor of image data captured by the camera, determines presence of the occupant within the interior of the equipped vehicle.

23. The vehicular occupant monitoring system of claim 22, wherein the camera is disposed behind and views through the mirror reflective element of the interior rearview mirror assembly.

24. The vehicular occupant monitoring system of claim 22, wherein the light polarization filter comprises a linear light polarization filter.

25. The vehicular occupant monitoring system of claim 22, wherein the light polarization filter comprises a circular light polarization filter.
